(19) United States
(12) Patent Application Publication
(10) Pub. No.: US 2026/0244839 A1
(43) Pub. Date: Aug. 20, 2026

(54) MODULARIZATION FOR DATA COLLECTION FOR LARGE DATA MODELS IN ADVANCED PACKAGING INTERCONNECTS

(71) Applicant: Georgia Tech Research Corporation, Atlanta, GA (US)

(72) Inventor: Mercy J. Daniel Aguebor, Atlanta, GA (US)

(21) Appl. No.: 19/541,942

(22) Filed: Feb. 17, 2026

Related U.S. Application Data
(60) Provisional application No. 63/758,416, filed on Feb. 14, 2025.

(51) Int. Cl. G06F 30/392; G06F 30/27; G06F 30/398; G06F 113/18; G06N 3/048; G06N 3/0499

(52) U.S. Cl. CPC G06F 30/392; G06F 30/27; G06F 30/398; G06N 3/048; G06N 3/0499; G06F 2113/18

(57) ABSTRACT

Modularized data collection and modeling for interconnect structures in advanced semiconductor packaging can utilize interconnect models representing distinct interconnect components, such as controlled collapse chip connection (C4) bumps, microstrip lines, striplines, and vias. Each interconnect model can encapsulate electrical characteristics of a corresponding interconnect structure, such as impedance, insertion loss, return loss, and frequency-dependent loss parameters. The interconnect models can be validated against empirical measurement data to align simulated interconnect behavior with real-world performance. Parameter data from each interconnect model can be cascaded to generate a system-level interconnect simulation. The interconnect models can be encoded into a predictive model that generates parameterized predictions based on interconnect design variations. The predictive model can enable rapid design space exploration by allowing adjustment of interconnect parameters such as trace width, substrate thickness, and material selection. Optimized interconnect configurations can be generated to meet signal integrity requirements, impedance matching, and thermal constraints.

### CROSS-REFERENCE TO RELATED APPLICATIONS

This application claims the benefit of and priority to U.S. Provisional Application No. 63/758,416, filed Feb. 14, 2025, titled “MODULARIZATION FOR DATA COLLECTION FOR LARGE DATA MODELS IN ADVANCED PACKAGING INTERCONNECTS,” the entire contents of which is hereby incorporated herein by reference.

### BACKGROUND

In semiconductor packaging, interconnect modeling and signal integrity analysis can involve full-wave electromagnetic simulations and iterative physical prototyping. Such methods can require extensive computational resources and time, as each design variation may necessitate a separate simulation or measurement to evaluate parameters such as impedance matching, insertion loss, return loss, and electromagnetic interference. Conventional approaches may rely on predefined design rules and empirical testing to refine interconnect performance, which can result in repeated design iterations to achieve desired electrical characteristics. Additionally, the characterization of interconnect structures, such as microstrip lines, striplines, vias, and controlled collapse chip connection (C4) bumps, may be conducted in isolation, which can require engineers to manually integrate performance data across multiple components to construct a system-level model. The lack of an efficient methodology for combining interconnect models into a unified, predictive framework can lead to increased design complexity, longer development cycles, and higher production costs in some cases.

### SUMMARY

Modularized data collection and modeling for interconnect structures in advanced semiconductor packaging is described. An example computer-implemented method can include defining a set of interconnect models associated with interconnect structures in a semiconductor package, wherein each interconnect model encapsulates electrical characteristics of a corresponding interconnect structure. The method can also include cascading parameter data from each interconnect model of the set of interconnect models to generate a system-level interconnect simulation. The method can also include encoding the set of interconnect models into a predictive model that generates parameterized predictions based on interconnect design variations.

In some examples, the set of interconnect models can include at least one of a controlled collapse chip connection (C4) bump model, a microstrip model, a stripline model, or a via model. In some examples, the method can further include, prior to cascading the parameter data, validating the set of interconnect models against empirical measurement data by comparing at least one of s-parameter data, impedance characteristics, or loss parameters from the set of interconnect models against physical measurements obtained from fabricated test structures. In some examples, cascading the parameter data can include applying a transmission matrix approach to integrate the set of interconnect models into a single transmission path for end-to-end model prediction. In some examples, the method can further include generating an optimized interconnect configuration based at least in part on the parameterized predictions, wherein generating the optimized interconnect configuration can include adjusting at least one of trace width, dielectric properties, substrate thickness, or signal routing based at least in part on at least one of signal integrity requirements, impedance matching, or thermal constraints.

An example system can include one or more processors and a memory storing instructions that, when executed by the one or more processors, cause the system to define a set of interconnect models associated with interconnect structures in a semiconductor package, wherein each interconnect model encapsulates electrical characteristics of a corresponding interconnect structure. The instructions can also cause the system to cascade parameter data from each interconnect model of the set of interconnect models to generate a system-level interconnect simulation. The instructions can also cause the system to encode the set of interconnect models into a predictive model that generates parameterized predictions based on interconnect design variations.

In some examples, the set of interconnect models can include at least one of a controlled collapse chip connection (C4) bump model, a microstrip model, a stripline model, or a via model. In some examples, the instructions can further cause the system to, prior to cascading the parameter data, validate the set of interconnect models against empirical measurement data by comparing at least one of s-parameter data, impedance characteristics, or loss parameters from the set of interconnect models against physical measurements obtained from fabricated test structures. In some examples, the instructions that cause the system to cascade the parameter data can include instructions that cause the system to apply a transmission matrix approach to integrate the set of interconnect models into a single transmission path for end-to-end model prediction. In some examples, the instructions can further cause the system to generate an optimized interconnect configuration based at least in part on the parameterized predictions, wherein generating the optimized interconnect configuration can include adjusting at least one of trace width, dielectric properties, substrate thickness, or signal routing based at least in part on at least one of signal integrity requirements, impedance matching, or thermal constraints. In some examples, the predictive model can include a feedforward neural network. The feedforward neural network can include multiple hidden layers employing a rectified linear unit (ReLU) activation function in some cases.

An example non-transitory computer-readable medium can store instructions that, when executed by one or more processors, cause the one or more processors to define a set of interconnect models associated with interconnect structures in a semiconductor package, wherein each interconnect model encapsulates electrical characteristics of a corresponding interconnect structure. The instructions can also cause the one or more processors to cascade parameter data from each interconnect model of the set of interconnect models to generate a system-level interconnect simulation. The instructions can also cause the one or more processors to encode the set of interconnect models into a predictive model that generates parameterized predictions based on interconnect design variations.

In some examples, the set of interconnect models can include at least one of a controlled collapse chip connection (C4) bump model, a microstrip model, a stripline model, or a via model. In some examples, the instructions can further cause the one or more processors to, prior to cascading the parameter data, validate the set of interconnect models against empirical measurement data by comparing at least one of s-parameter data, impedance characteristics, or loss parameters from the set of interconnect models against physical measurements obtained from fabricated test structures. In some examples, the instructions that cause the one or more processors to cascade the parameter data can include instructions that cause the one or more processors to apply a transmission matrix approach to integrate the set of interconnect models into a single transmission path for end-to-end model prediction. In some examples, the predictive model can include a feedforward neural network comprising multiple hidden layers employing a rectified linear unit (ReLU) activation function. In some examples, the instructions can further cause the one or more processors to generate an optimized interconnect configuration based at least in part on the parameterized predictions, wherein generating the optimized interconnect configuration can include adjusting at least one of trace width, dielectric properties, substrate thickness, or signal routing based at least in part on at least one of signal integrity requirements, impedance matching, or thermal constraints.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 depicts a heterogeneous semiconductor packaging architecture according to an example implementation.

FIG. 2A depicts a conventional design flow methodology for semiconductor packaging according to an example implementation.

FIG. 2B depicts a modularized data-driven interconnect design flow methodology for semiconductor packaging according to an example implementation.

FIG. 3 depicts a modularized interconnect modeling system for semiconductor packaging according to an example implementation.

FIG. 4 depicts a method for analyzing and optimizing interconnect performance in semiconductor packaging according to an example implementation.

FIG. 5 depicts a computer system according to an example implementation.

### DETAILED DESCRIPTION

The present disclosure generally relates to modularized data collection and modeling for interconnect structures in advanced semiconductor packaging. Conventional simulation models for interconnect design can be limited to single-use applications and constrained by specific material properties, which can reduce efficiency when applied across heterogeneous integration architectures involving multiple substrate types and interconnect configurations.

According to various implementations described herein, a modularized approach to interconnect modeling can utilize pre-validated module data structures that facilitate large-scale model adaptability across various materials, including organic substrates, silicon, and glass. The modularized approach can structure interconnect data into reusable components, such as models for controlled collapse chip connection (C4) bumps, microstrip lines, striplines, and vias, which can be cascaded to generate system-level interconnect simulations. By leveraging pre-characterized interconnect models in combination with hardware correlation and machine-learning-driven encoding, the systems and methods described herein can accelerate design space exploration, reduce computational overhead, and enhance the accuracy of interconnect performance predictions.

In one or more implementations, a modularized interconnect modeling system receives an input signal and processes the signal through a series of pre-validated interconnect models representing distinct interconnect components in a semiconductor package. Each interconnect model can encapsulate predefined electrical characteristics, such as impedance, insertion loss, return loss, and frequency-dependent loss parameters. The system can cascade s-parameter data from each interconnect model to generate a comprehensive system-level simulation, validate predicted performance against empirical hardware measurements, and encode the modular interconnect data into a machine-learning-driven predictive model. The predictive model can enable real-time parameterized predictions based on interconnect design variations. The predictive model can allow designers to rapidly explore the design space and optimize package configurations for signal integrity, impedance matching, and thermal constraints.

The following definitions are provided to clarify the meaning of terms used throughout this disclosure. These definitions are intended to supplement the understanding of a person having ordinary skill in the art and are not intended to limit the scope of the claims.

C4 Bump Model: A representation of controlled collapse chip connection (C4) solder bumps used to connect a silicon die to an interposer or substrate in an advanced package. The C4 bump model captures impedance mismatches, parasitic capacitance, and insertion loss at the interface.

Microstrip Model: A transmission line structure consisting of a metal trace on top of a dielectric substrate with a ground plane beneath it. The microstrip model characterizes dielectric constant (εᵣ), loss tangent (δ), crosstalk (S), and insertion loss (S₂₁) for high-speed interconnects.

Stripline Model: A transmission line fully embedded within a dielectric material, sandwiched between two ground planes. The stripline model provides better shielding and reduced radiation loss compared to microstrip configurations.

Via/Transition Model: A model for vertical interconnects (vias) that connect different layers of a multi-layer printed circuit board (PCB) or semiconductor package, capturing signal reflections, impedance discontinuities, and transition losses.

Dielectric Constant (εᵣ): A material property determining the electric field propagation through a dielectric medium. The dielectric constant affects signal speed and impedance in microstrip and stripline designs.

Loss Tangent (δ): A measure of a dielectric material's inherent energy loss under an oscillating electric field, impacting signal attenuation and insertion loss (S₂₁).

Insertion Loss (S₂₁): A measure of signal power lost as it propagates through an interconnect system, expressed in decibels (dB). Lower insertion loss indicates better transmission.

Return Loss (S₁₁): A measure of reflected signal power due to impedance mismatches in a transmission line. Higher return loss indicates better impedance matching.

Skin Effect: A phenomenon where high-frequency currents concentrate on a conductor's surface, increasing effective resistance and signal loss.

Surface Finish Loss: Signal degradation caused by conductor surface roughness and plating materials, which increase resistance.

Dispersion Effects: Frequency-dependent changes in a material's dielectric properties, affecting signal velocity and phase distortion.

Characteristic Impedance (Z0): The inherent opposition to signal flow in a transmission line, dependent on trace width (w), substrate height (h), and dielectric constant (εᵣ).

Crosstalk Spacing (S): The physical distance between adjacent signal traces in a microstrip or stripline structure. The crosstalk spacing directly influences electromagnetic coupling and interference between signals.

S-Parameters (Scattering Parameters): A mathematical representation of how an electrical network responds to incoming and outgoing power waves, commonly used in RF and high-speed interconnect modeling.

Cascaded S-Parameters: The process of combining individual s-parameter models (e.g., C4 bump, microstrip, via) to form an end-to-end interconnect model for system-wide analysis.

Feedforward Neural Network (FNN): A type of artificial neural network (ANN) where data moves in one direction, from input to output, without looping back. An FNN is used to predict interconnect performance using pre-trained data.

ReLU (Rectified Linear Unit) Activation Function: A widely used activation function in neural networks that outputs zero for negative values and the value itself for positive inputs, improving model efficiency.

Surrogate Model: A simplified, computationally efficient model that approximates the behavior of a more complex system. A surrogate model is used to reduce computation time in interconnect modeling.

Model Generalization: The ability of a trained machine learning model to perform accurately on unseen data, ensuring scalability of interconnect predictions.

Pre-Validated Modular Models: Pre-defined models encompassing multiple parameters covering a design space and correlated with measurement.

Model Reuse: The process of applying pre-trained models to new datasets without retraining from scratch, allowing faster interconnect simulations with pre-validated modular models.

Design Space Exploration (DSE): The process of analyzing multiple design parameters to identify optimal configurations for electrical performance, impedance matching, and thermal constraints.

Hardware Correlation: The process of matching simulation data with real-world hardware measurements to validate model accuracy and ensure alignment with physical interconnect behavior.

Adaptive Model Refinement: A method where a predictive model updates itself as new data is introduced, improving accuracy over time and reducing the need for manual recalibration.

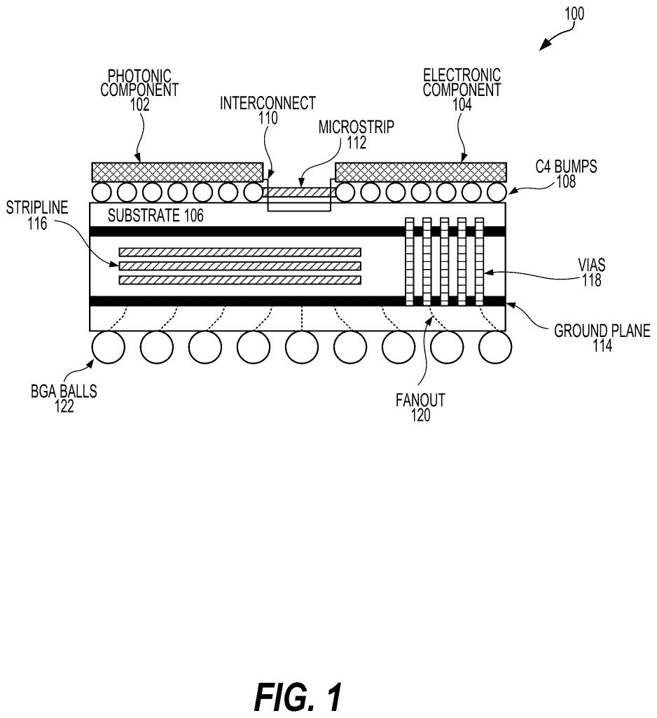

FIG. 1 depicts a heterogeneous semiconductor packaging architecture 100 according to an example implementation. The heterogeneous semiconductor packaging architecture 100 integrates a photonic component 102 (e.g., a first chiplet) and an electronic component 104 (e.g., a second chiplet) within a shared substrate 106. The photonic component 102 and the electronic component 104 can each be connected to the substrate 106 through one or more C4 bumps 108, which form electrical and mechanical connections between the photonic component 102 and the substrate 106 and between the electronic component 104 and the substrate 106. An interconnect 110 provides direct electrical communication between the photonic component 102 and the electronic component 104, which can minimize signal propagation delay and optimize bandwidth for high-speed data transmission.

The substrate 106 provides structural support and electrical pathways for signal transmission. A microstrip 112 is positioned on the uppermost layer of the substrate 106 and includes a conductive signal trace with an underlying ground plane 114. The microstrip 112 is a transmission line structure where the signal trace is placed above a dielectric substrate with a ground plane beneath it, which can provide controlled impedance and low-loss signal propagation.

A stripline 116 is embedded within the substrate 106 and is positioned between two ground planes 114. The stripline 116 is a transmission line structure in which the signal conductor is sandwiched between two ground planes within a dielectric material. The ground planes 114 are continuous conductive layers that provide a reference potential for signal transmission and serve as return paths for electrical currents, which can minimize electromagnetic interference (EMI) and ensure controlled impedance across the interconnect structure.

Vias 118 serve as vertical interconnections between different signal layers within the substrate 106. A via 118 is a conductive pathway that can enable signal transitions between layers while maintaining impedance continuity. The vias 118 can facilitate transitions between the microstrip 112 and the stripline 116 and can ensure low-loss interconnectivity in multi-layer semiconductor packaging.

A fanout 120 to a ball grid array (BGA) routes signals from the internal interconnect layers of the substrate 106 to BGA balls 122, which provide external electrical connections to a printed circuit board (PCB) or other system components. A BGA is a packaging technology in which solder balls can be used to establish electrical connections between the semiconductor package and an external circuit board.

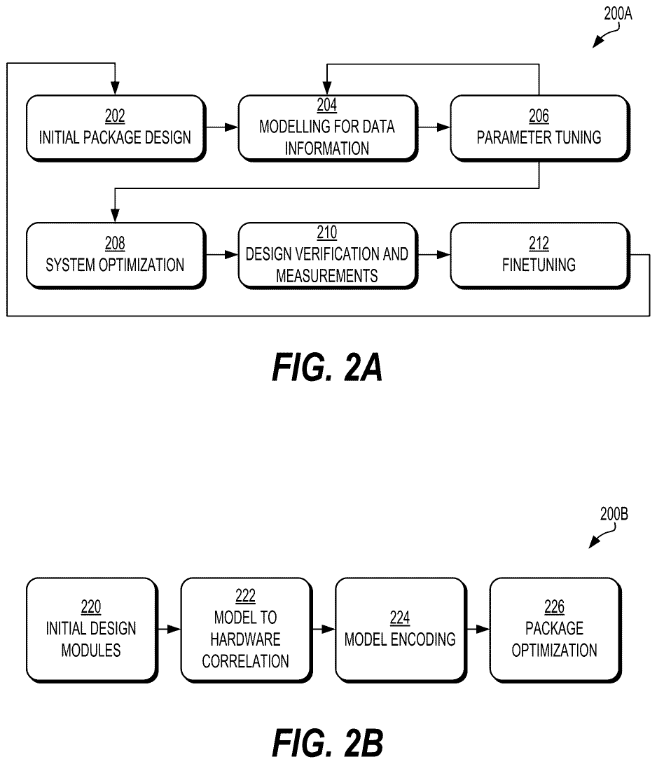

FIG. 2A depicts a conventional design flow methodology 200A for semiconductor packaging according to an example implementation. The methodology 200A begins with an initial package design 202, where designers can select the material, topology, and initial stackup for the interconnect architecture. The initial package design 202 is followed by a modeling for data information phase 204, where electromagnetic, thermal, and structural simulations can be conducted to evaluate signal integrity, impedance matching, and loss characterization. The modeling for data information phase 204 can be computationally intensive and may require refinements that are time-consuming.

After modeling, the design enters a parameter tuning phase 206, where specific interconnect parameters, such as material selection, trace width, and substrate thickness, can be adjusted. If results are not satisfactory, designers may need to return to the modeling for data information phase 204, which can increase design cycle duration. The next phase is a system optimization phase 208 in which the package can be analyzed for thermal dissipation, power integrity, and manufacturability.

Following the system optimization phase 208, a design verification and measurements phase 210 can be used to determine whether the design meets performance requirements through hardware testing or high-fidelity simulations. If the verification results do not align with the expected performance, further modifications are made, often requiring a return to earlier stages, significantly extending the design timeline. A fine-tuning phase 212 makes additional refinements, but major discrepancies at this stage may require restarting the cycle, delaying project completion.

The conventional design flow 200A can be highly iterative, time-consuming, and computationally expensive, relying on manual adjustments and extensive verification cycles before achieving an optimized package design.

As indicated in FIG. 2A, the conventional design flow 200A can include iterative feedback paths, such as from the parameter tuning phase 206 back to the modeling for data information phase 204, or from the fine-tuning phase 212 back to the initial package design 202.

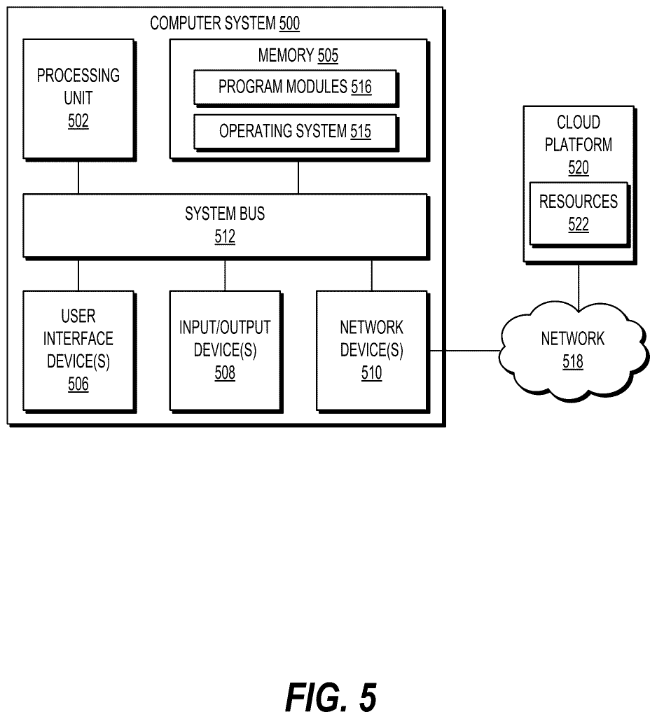

FIG. 2B depicts a modularized data-driven interconnect design flow methodology 200B for semiconductor packaging according to an example implementation. The methodology 200B can be executed on a variety of computing platforms, ranging from off-the-shelf computer systems to cloud-based high-performance computing (HPC) environments, as described in more detail with reference to FIG. 5. The choice of hardware can depend on factors such as the scale of interconnect modeling, computational complexity, and the need for real-time processing.

For small-scale or prototype-level simulations, the methodology 200B can be implemented on a general-purpose computing system, such as a desktop workstation or high-end laptop. These systems can include multi-core processors for handling numerical computations, graphics processing units (GPUs) or accelerators for AI-driven encoding and predictive modeling, and high-speed storage to manage large datasets and simulation results. Operating systems supporting electronic design automation (EDA) tools and machine-learning frameworks can be used to facilitate efficient execution of the methodology 200B.

For mid-to-large-scale interconnect modeling, high-performance workstations can be implemented to provide enhanced computational power. These systems can feature server-grade processors with greater parallel processing capabilities, expanded memory capacity to handle large datasets, and dedicated AI and simulation accelerators for optimizing complex machine-learning-driven encoding models. Advanced EDA software suites, AI-driven predictive analytics tools, and high-speed simulation frameworks can be implemented to further enhance the ability of the system to perform model-to-hardware correlation, machine-learning-driven optimization, and real-time design iteration.

For enterprise-level or large-scale semiconductor design, the methodology 200B can be deployed in cloud-based or on-premises HPC environments, leveraging distributed computing and parallel processing for large-scale simulations. Cloud computing platforms can offer high-performance virtualized computing instances, with access to specialized AI accelerators, deep-learning training resources, and scalable storage solutions. The use of EDA cloud services and AI-driven inference engines can enable designers to conduct real-time optimization and validation without the constraints of local hardware limitations.

In addition to traditional computing systems, field-programmable gate arrays (FPGAs) and application-specific integrated circuits (ASICs) can be used for hardware-accelerated AI modeling and real-time interconnect validation. These hardware solutions can be particularly useful for applications requiring low-latency, high-throughput signal processing and on-the-fly interconnect adjustments based on empirical data. By integrating FPGA-or ASIC-based computing platforms with real-time measurement systems, the methodology 200B can directly process hardware validation data and continuously refine interconnect performance predictions.

The scalability and flexibility of the methodology 200B can allow the methodology 200B to be implemented across a range of computing environments, from desktop workstations for rapid prototyping to HPC and cloud-based solutions for large-scale interconnect optimization. By leveraging multi-core processing, AI acceleration, and distributed computing resources, the methodology 200B can enable efficient design iterations, real-time predictive modeling, and enhanced accuracy in semiconductor interconnect design.

The modularized data-driven interconnect design flow methodology 200B can streamline the interconnect design process by reducing design iterations and computational effort, which can improve efficiency and scalability in semiconductor packaging design. Unlike traditional iterative methods that may require repeated full-wave simulations and manual design adjustments, the methodology 200B can integrate pre-validated modular interconnect models, hardware correlation, and artificial intelligence-driven encoding to accelerate design convergence while maintaining accuracy and flexibility. By employing data-driven design principles, the methodology 200B can allow for a structured and automated approach to interconnect modeling, which can provide high fidelity while reducing computational overhead.

The methodology 200B begins with the execution of initial design operations 220, where instead of starting from a blank slate, the system can leverage pre-validated, reusable interconnect models associated with interconnect structures such as C4 bumps, microstrip lines, striplines, vias, combinations thereof, and/or the like. By utilizing pre-characterized interconnect components, the methodology 200B can provide compatibility with various material types, process technologies, and packaging configurations, which can reduce or eliminate the need for time-intensive initial modeling and verification. This approach can allow designers to focus on higher-level optimization and customization, rather than manually defining basic interconnect structures.

Following the initial design operations 220, a model-to-hardware correlation phase 222 can be performed to align simulation models with empirical hardware measurements. This phase can aid in achieving high-confidence interconnect performance predictions, as simulated models alone may not account for variability in manufacturing processes, material properties, and environmental conditions. The model-to-hardware correlation phase 222 can involve comparing s-parameter data, impedance characteristics, and loss parameters from simulations against physical measurements obtained from fabricated test structures. By integrating measurement-based validation techniques, the methodology 200B can reduce reliance on full-scale simulations for each design iteration, which can improve design accuracy while increasing computational efficiency.

Once the simulation models are hardware-validated, the process advances to a model encoding phase 224, where a machine-learning-driven framework can convert the modular interconnect data into an adaptive predictive system. This artificial intelligence-assisted encoding process can enable real-time parameterized predictions, allowing designers to rapidly explore the design space by adjusting interconnect parameters such as trace width, substrate thickness, material selection, and spacing constraints. The adaptive predictive system can continuously refine its predictions based on new data inputs, which can help ensure that simulated interconnect behavior aligns with empirical hardware measurements, such as vector network analyzer (VNA) results and time-domain reflectometry (TDR) readings. By leveraging AI-based surrogate modeling, the methodology 200B can minimize computational load by replacing resource-intensive full-wave electromagnetic simulations with high-fidelity, real-time predictive models. The system can dynamically adapt to new interconnect configurations, material properties, and manufacturing constraints, enabling rapid design space exploration and iterative refinement. Additionally, the machine-learning-driven framework can improve over time by learning from previously validated designs, making the framework scalable and adaptable to emerging semiconductor packaging technologies.

In some implementations, the machine-learning-driven framework of the model encoding phase 224 can include a feedforward neural network (FNN) with a sequential architecture. The FNN can include multiple hidden layers, each containing multiple neurons and employing an activation function such as the rectified linear unit (ReLU) activation function. The sequential network architecture can enable efficient training on interconnect simulation data and hardware measurement results.

In some cases, a surrogate model can be used for frequency correlation to reduce computation time while maintaining prediction accuracy. The surrogate model can approximate the behavior of more complex full-wave electromagnetic simulations, enabling rapid evaluation of interconnect performance across a range of frequencies without requiring computationally intensive simulations for each frequency point.

The adaptive predictive system can also incorporate additional physical effects to improve prediction accuracy. For example, the system can account for skin effect, surface finish loss, and dispersion effects. By including these physical effects in the model encoding phase 224, the adaptive predictive system can generate predictions that more closely align with empirical hardware measurements and real-world interconnect behavior.

Finally, a package optimization phase 226 can utilize the pre-validated interconnect models and artificial intelligence-enhanced predictions to achieve desired interconnect performance. This phase can involve automatically generating optimized configurations that balance multiple design constraints, including signal integrity, impedance matching, thermal dissipation, and manufacturability. By automating the optimization process, the system can minimize the need for manual tuning, allowing engineers to achieve higher-performing interconnect designs in less time. The package optimization phase 226 can integrate the AI-driven predictions with design rule constraints and manufacturing considerations to help ensure that the final interconnect layout is both efficient and fabrication-ready.

By integrating pre-validated models, hardware correlation techniques, machine learning-based encoding, and automated package optimization, the modularized data-driven interconnect design flow methodology 200B can enhance efficiency, accuracy, and scalability in semiconductor packaging design. The data-driven approach can allow for faster convergence, reduced development costs, and greater flexibility in exploring advanced interconnect architectures.

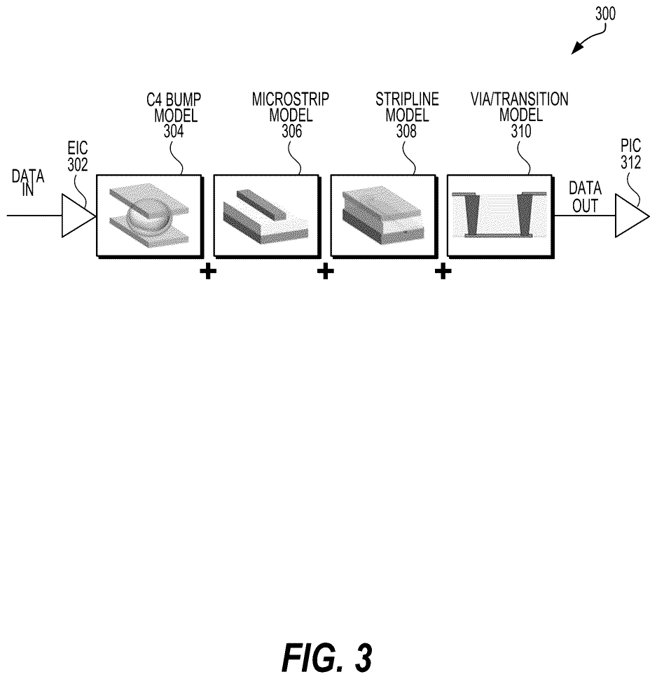

FIG. 3 depicts a modularized interconnect modeling system 300 for semiconductor packaging according to an example implementation. The system 300 can simulate signal transmission through multiple interconnect components in a structured and scalable manner. The system 300 includes an electromagnetic interconnect controller (EIC) 302, a series of pre-validated interconnect models 304, 306, 308, 310, and a photonic integrated circuit (PIC) output 312, which can enable efficient modeling and optimization of interconnect performance across different semiconductor packaging configurations.

The EIC 302 receives an electrical input signal (shown as “data in”) and manages signal routing through the system 300. The C4 bump model 304 represents a controlled collapse chip connection (C4) bump, which provides electrical connectivity between a semiconductor die and an underlying substrate. The C4 bump model 304 characterizes impedance mismatches, contact resistance, and parasitic effects that occur at the die-to-substrate interface.

The signal is then processed through the microstrip model 306, which simulates a surface-layer transmission line where a conductive trace is placed over a dielectric substrate with a ground plane beneath it. The microstrip model 306 accounts for key design parameters such as trace width, dielectric constant, loss tangent, and crosstalk spacing, which can provide proper impedance matching and minimal insertion loss (S₂₁).

In some implementations, data for the microstrip model 306 can be generated across a range of parameter values to cover a generalized design space. For example, the dielectric constant (εᵣ) can range from approximately 1 to approximately 128 to accommodate various substrate materials including air, organic substrates, silicon, and glass. The frequency range can extend up to approximately 100 gigahertz (GHz) or higher to support high-speed interconnect applications. The loss tangent (δ) can range from approximately 0.0001 to approximately 0.1 to account for both low-loss and higher-loss dielectric materials. The crosstalk spacing (S) can range up to approximately 1000 micrometers (μm) or more. The microstrip model 306 can be configured with scalable length parameters, such as loss per millimeter, to enable flexible interconnect length modeling. The output parameter of primary interest can include the insertion loss (S21), which characterizes signal power lost as the signal propagates through the microstrip transmission line.

For data generation that includes crosstalk effects, simplifying assumptions can be made to reduce computational complexity while maintaining model accuracy. For example, for signals propagating in the same direction, a worst-case crosstalk scenario can be assumed in which maximum crosstalk occurs with similar traces positioned on either side of the signal line. This assumption can enable efficient generation of crosstalk data that captures the upper bounds of electromagnetic coupling between adjacent signal traces. Similar assumptions can be applied to data generation for via structures and other interconnect components. Inter-layer modular data, which characterizes electromagnetic interactions between signal traces on different layers of a multi-layer substrate, can be generated using approaches similar to those used for crosstalk data generation.

During data generation for the microstrip model 306, impedance matching can be maintained by applying appropriate characteristic impedance formulas based on the geometric parameters of the microstrip structure. For example, different formulas can be applied depending on whether the ratio of trace width (w) to substrate height (h) is greater than or less than a threshold value, such as 1. When w/h is greater than 1, a first set of formulas can be used to calculate the characteristic impedance, and when w/h is less than 1, a second set of formulas can be applied. This approach can help ensure that the generated data accurately reflects the impedance characteristics of microstrip transmission lines across a range of geometric configurations. Similar impedance-aware data generation approaches can be applied to stripline models and other transmission line structures.

Next, the signal propagates through the stripline model 308, which differs from the microstrip model 306 in that the signal trace is embedded within the dielectric material between two ground planes. This configuration reduces electromagnetic interference (EMI) and improves signal integrity by providing enhanced shielding. The stripline model 308 incorporates substrate thickness, conductor width, and frequency-dependent loss characteristics to maintain controlled impedance and minimize signal degradation.

The system 300 further includes a via/transition model 310, which represents vertical interconnects that enable signal transitions between different substrate layers. The via model 310 accounts for impedance discontinuities, transition losses, and signal reflections, which can enable stable propagation across multiple interconnect layers.

The processed signal is then output through the PIC output 312, which serves as the final transition point before the signal reaches its external destination (shown as “data out”).

The modularized interconnect modeling system 300 can enable efficient and reusable interconnect simulations by leveraging pre-characterized interconnect models, including the C4 bump model 304, the microstrip model 306, stripline model 308, and via/transition model 310. The system 300 integrates these modular models into a cascaded signal path such that individual s-parameters from each interconnect component contribute to a comprehensive system-level simulation. This approach reduces the need for full-wave simulations at every design iteration, which can allow for rapid design space exploration while maintaining high computational efficiency.

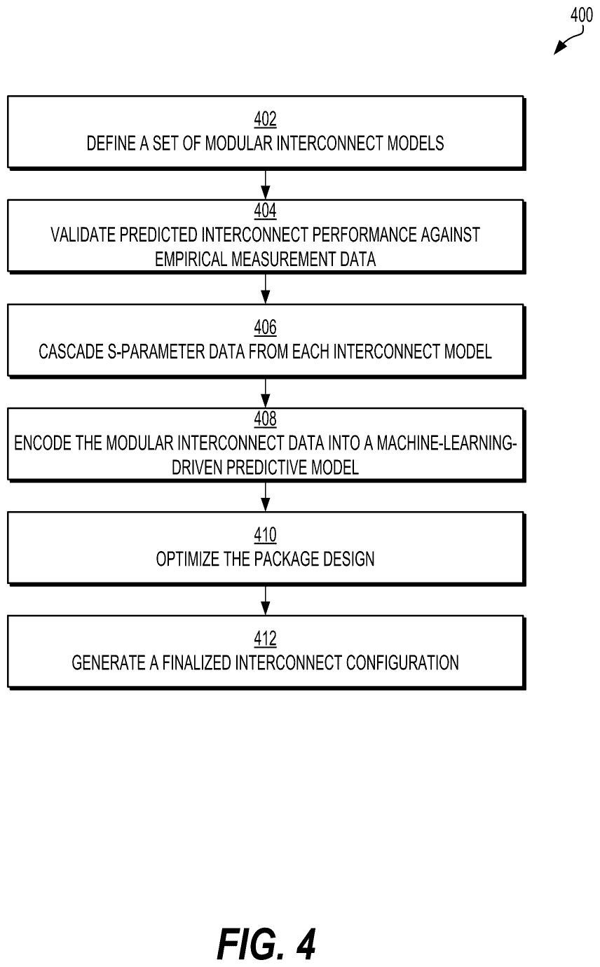

FIG. 4 depicts a method 400 for analyzing and optimizing interconnect performance in semiconductor packaging according to an example implementation. The method 400 can be performed by the modularized interconnect modeling system 300, which can leverage pre-validated interconnect models, hardware correlation, and machine-learning-driven optimization to facilitate rapid design iterations while minimizing the need for full-wave electromagnetic simulations.

It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

The method 400 begins at block 402, where the system 300 defines a set of modular interconnect models, including at least a C4 bump model, microstrip model, stripline model, and via/transition model. These models represent distinct interconnect components used in semiconductor packaging and encapsulate predefined electrical characteristics such as impedance, insertion loss (S21), return loss (S11), and frequency-dependent losses. In some implementations, a semiconductor package can be automatically generated in a simulator as a set of pre-defined interconnect modules. The pre-defined interconnect modules can include at least one of a C4 bump model, a microstrip model, a stripline model, or a via model. By automatically generating the package from pre-defined interconnect modules, the system 300 can enable rapid assembly of interconnect architectures without requiring manual configuration of each individual component.

At block 404, the system 300 validates the predicted interconnect performance against empirical measurement data. The validation process can involve comparing at least one of s-parameter data, impedance characteristics, or loss parameters from the system-level interconnect simulation against physical measurements obtained from fabricated test structures. In some implementations, the empirical measurement data can be obtained from hardware validation techniques, which can account for variability in manufacturing processes, material properties, and environmental conditions that may not be fully captured by simulated models alone. The correlation process can help ensure that the simulated interconnect behavior aligns with real-world performance, which can allow the system 300 to refine interconnect models based on measured impedance mismatches, loss variations, and crosstalk effects. In some cases, the validation process can be performed iteratively, where discrepancies between predicted and measured performance are used to update the pre-validated interconnect models, which can improve the accuracy of subsequent simulations. By integrating measurement-based validation, the system 300 can reduce reliance on full-scale simulations for each design iteration, which can improve design accuracy while increasing computational efficiency.

At block 406, the system 300 cascades s-parameter data from each interconnect model, which can generate a comprehensive system-level interconnect simulation. In some implementations, a transmission matrix approach can be applied to integrate the individual interconnect components into a single transmission path for end-to-end model prediction, which can enable signal propagation analysis from input to output. The modular nature of the models allows the system 300 to evaluate new interconnect designs without requiring full-wave simulations or extensive redesigns.

At block 408, the system 300 encodes the modular interconnect data into a machine-learning-driven predictive model, which refines interconnect performance predictions based on training data derived from previous simulations and hardware measurements. The system 300 can enable real-time parameterized predictions, which can reduce computational overhead and allow for efficient optimization of interconnect configurations.

The accuracy of the machine-learning-driven predictive model can be characterized by comparing the predicted interconnect performance against empirical measurement data. In some implementations, the predictions can achieve accuracy within a threshold percentage, such as within approximately 10 percent, of the measured output values (e.g., insertion loss in decibels). The accuracy of the model can be informative of the amount of training data collected, and additional data can be collected to improve accuracy over time. Because the predictive model is a generalized model designed to accommodate various material properties and interconnect configurations, additional data can continue to be incorporated into the model in the context of model reuse. As the model continues to learn from new simulation results and hardware measurements, the prediction accuracy can improve, which can enable increasingly reliable interconnect performance predictions across a broader range of design configurations.

At block 410, the system 300 optimizes the package design by adjusting interconnect parameters such as trace width, dielectric properties, substrate thickness, and signal routing strategies. The optimization process can help ensure that the final design meets signal integrity requirements, including impedance matching, minimal signal loss, and controlled EMI.

At block 412, the system 300 generates a finalized interconnect configuration, incorporating the optimized parameters into the semiconductor packaging design. The validated and optimized model is stored by the system 300 and can be applied to new designs or reused across multiple semiconductor packaging configurations, which can enhance design scalability and efficiency.

The method 400, executed by the system 300, can enable automated and scalable interconnect modeling by integrating pre-validated modular models, hardware correlation, and AI-driven optimization techniques. By performing each operation, the system 300 can reduce computational complexity, accelerate design iterations, and enhance the accuracy of interconnect performance predictions, which can provide an efficient and reliable interconnect modeling process.

FIG. 5 depicts a computer system 500 that can provide the functionality in accordance with various implementations disclosed herein. The systems, devices, and other components disclosed herein can utilize, at least in part, an architecture that is the same as or at least similar to the architecture of the computer system 500, for example, the system 300 or one or more of the components thereof. It should be understood, however, that modification to the architecture may be made to facilitate certain interactions among elements described herein. As described with reference to FIG. 2B, the methodology 200B can be executed on a variety of computing platforms, and the computer system 500 represents an example of such a computing platform.

The computer system 500 includes a processing unit 502, a memory 504, one or more user interface devices 506, one or more input/output (“I/O”) devices 508, and one or more network devices 510, each of which is operatively connected to a system bus 512. The system bus 512 enables bi-directional communication between the processing unit 502, the memory 504, the user interface devices 506, the I/O devices 508, and the network devices 510.

The processing unit 502 may be a standard central processor that performs arithmetic and logical operations, a more specific purpose programmable logic controller (“PLC”), a programmable gate array, or other type of processor known to those skilled in the art and suitable for controlling the operation of the computer system 500. Processing units are known, and therefore are not described in further detail herein.

The memory 504 communicates with the processing unit 502 via the system bus 512. In some implementations, the memory 504 is operatively connected to a memory controller (not shown) that enables communication with the processing unit 502 via the system bus 512. The illustrated memory 504 includes an operating system 514 and one or more program modules 516. The operating system 514 can include, but is not limited to, members of the WINDOWS family of operating systems from MICROSOFT CORPORATION, the LINUX family of operating systems, the MAC OS family of operating systems from APPLE CORPORATION, the FREEBSD family of operating systems, the SOLARIS family of operating systems from ORACLE CORPORATION, other operating systems, and the like.

The program modules 516 may include various software and/or program modules to perform the various operations described herein. The program modules 516 and/or other programs can be embodied in computer-readable media containing instructions that, when executed by the processing unit 502, perform various operations such as those described herein with respect to the design flow methodology 200B and/or the method 400. According to implementations, the program modules 516 may be embodied in hardware, software, firmware, or any combination thereof.

By way of example, and not limitation, computer-readable media may include any available computer storage media or communication media that can be accessed by the computer system 500. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared, and other wireless media. Combinations of the any of the above should also be included within the scope of computer-readable media.

Computer storage media includes volatile and non-volatile, removable, and non-removable media implemented in any method or technology for storage of information such as computer-readable instructions, data structures, program modules, or other data. Computer storage media includes, but is not limited to, random access memory (RAM), read-only memory (ROM), erasable programmable ROM (“EPROM”), electrically erasable programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 500. In the claims, the phrase “computer-readable storage medium” and variations thereof does not include waves or signals per se and/or communication media.

The user interface devices 506 may include one or more devices with which a user accesses the computer system 500. The user interface devices 506 may include, but are not limited to, computers, servers, PDAs, cellular phones, or any suitable computing devices. The I/O devices 508 enable a user to interface with the program modules 516. In one embodiment, the I/O devices 508 are operatively connected to an I/O controller (not shown) that enables communication with the processing unit 502 via the system bus 512. The I/O devices 508 may include one or more input devices, such as, but not limited to, a keyboard, a mouse, or an electronic stylus. Further, the I/O devices 508 may include one or more output devices, such as, but not limited to, a display screen or a printer. In some implementations, the I/O devices 508 can be used for manual controls for operations to exercise under certain emergency situations.

The network devices 510 enable the computer system 500 to communicate with other networks or remote systems via a network 518. Examples of the network devices 510 include, but are not limited to, a modem, a radio frequency (“RF”) or infrared (“IR”) transceiver, a telephonic interface, a bridge, a router, a switch, and a network card.

Aspects described herein are supported by various configurations of the computer system 500 and are not limited to the specific examples of the concepts and technologies described herein. This functionality is also implementable all or in part through use of a distributed system, such as over a network 518 via a cloud platform 520 as described below.

The network 518 includes and/or is representative of a cloud platform 520 for resources 522. The cloud platform 520 abstracts underlying functionality of hardware (e.g., servers) and software resources of the network 518. The resources 522 include applications and/or data that can be utilized while computer processing is executed on servers that are remote from the computer system 500. Resources 522 can also include services provided over the Internet and/or through a subscriber network, such as a cellular or Wi-Fi network.

The cloud platform 520 abstracts resources and functions to connect the computer system 500 with other computing devices. The cloud platform 520 also serves to abstract scaling of resources to provide a corresponding level of scale to encountered demand for the resources 522 that are implemented via the cloud platform 520. Accordingly, in an interconnected device, implementation of functionality described herein is distributable throughout the computer system 500. For example, the functionality is implementable in part on the computer system 500 as well as via the cloud platform 520 that abstracts the functionality of the network 518.

In implementations, the cloud platform 520 can employ a machine-learning model that is configured to implement the concepts and technologies described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, feedforward neural network (FNN), convolutional neural networks (CNNs), long short-term memory (LSTM) neural networks, decision trees, and so forth.

The present disclosure describes a modularized interconnect modeling system for advanced semiconductor packaging, which can integrate pre-validated, reusable interconnect models to enable efficient, scalable, and computationally optimized signal integrity analysis. By structuring the interconnect modeling process into modular components, including, for example, C4 bump models, microstrip models, stripline models, and via/transition models, the system can enable cascaded s-parameter integration, which can reduce the reliance on full-wave simulations and facilitate rapid design iterations.

The system can introduce a data-driven approach that incorporates hardware correlation, model encoding, and machine-learning-assisted surrogate modeling to refine interconnect performance across varying material properties and signal transmission configurations. The ability to reuse and adapt pre-characterized models can enhance design flexibility, signal integrity prediction accuracy, and computational efficiency, which can make this system particularly suitable for high-speed, heterogeneous semiconductor architectures.

Unlike conventional design methodologies that may require extensive iterative simulations and physical prototyping, the present disclosure describes a structured, scalable interconnect modeling system that can support diverse semiconductor packaging designs with minimized computational overhead and accelerated time-to-market. The integration of modularized interconnect models, AI-driven prediction, and early-stage hardware validation can provide an efficient interconnect optimization framework, which can enable next-generation semiconductor devices to achieve enhanced signal integrity, improved design predictability, and increased manufacturing efficiency.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The features, structures, or characteristics described above may be combined in one or more implementations in any suitable manner, and the features discussed in the various implementations are interchangeable, if possible. In the following description, numerous specific details are provided in order to fully understand the implementations of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described implementations of the present disclosure are merely possible examples set forth for a clear understanding of the principles of the disclosure. Many variations and modifications may be made to the above-described implementations without departing substantially from the spirit and principles of the disclosure. All such modifications and variations are intended to be included herein within the scope of this disclosure and protected by the following claims.

Therefore, the following is claimed:

1. A computer-implemented method comprising:
defining a set of interconnect models associated with interconnect structures in a semiconductor package, wherein each interconnect model encapsulates electrical characteristics of a corresponding interconnect structure;
cascading parameter data from each interconnect model of the set of interconnect models to generate a system-level interconnect simulation; and
encoding the set of interconnect models into a predictive model that generates parameterized predictions based on interconnect design variations.

2. The computer-implemented method of claim 1, wherein the set of interconnect models comprises at least one of a controlled collapse chip connection (C4) bump model, a microstrip model, a stripline model, or a via model.

3. The computer-implemented method of claim 2, further comprising, prior to cascading the parameter data, validating the set of interconnect models against empirical measurement data by comparing at least one of s-parameter data, impedance characteristics, or loss parameters from the set of interconnect models against physical measurements obtained from fabricated test structures.

4. The computer-implemented method of claim 1, wherein cascading the parameter data comprises applying a transmission matrix approach to integrate the set of interconnect models into a single transmission path for end-to-end model prediction.

5. The computer-implemented method of claim 1, wherein the predictive model comprises a feedforward neural network.

6. The computer-implemented method of claim 1, wherein defining the set of interconnect models comprises automatically generating, in a simulator, the set of interconnect models from pre-defined interconnect modules.

7. The computer-implemented method of claim 1, further comprising generating an optimized interconnect configuration based at least in part on the parameterized predictions, wherein generating the optimized interconnect configuration comprises adjusting at least one of trace width, dielectric properties, substrate thickness, or signal routing based at least in part on at least one of signal integrity requirements, impedance matching, or thermal constraints.

8. A system comprising:
one or more processors; and
a memory storing instructions that, when executed by the one or more processors, cause the system to:
define a set of interconnect models associated with interconnect structures in a semiconductor package, wherein each interconnect model encapsulates electrical characteristics of a corresponding interconnect structure;
cascade parameter data from each interconnect model of the set of interconnect models to generate a system-level interconnect simulation; and
encode the set of interconnect models into a predictive model that generates parameterized predictions based on interconnect design variations.

9. The system of claim 8, wherein the set of interconnect models comprises at least one of a C4 bump model, a microstrip model, a stripline model, or a via model.

10. The system of claim 8, wherein the memory stores further instructions that, when executed by the one or more processors, cause the system to, prior to cascading the parameter data, validate the set of interconnect models against empirical measurement data by comparing at least one of s-parameter data, impedance characteristics, or loss parameters from the set of interconnect models against physical measurements obtained from fabricated test structures.

11. The system of claim 8, wherein the instructions that cause the system to cascade the parameter data comprise instructions that cause the system to apply a transmission matrix approach to integrate the set of interconnect models into a single transmission path for end-to-end model prediction.

12. The system of claim 8, wherein the predictive model comprises a feedforward neural network.

13. The system of claim 12, wherein the feedforward neural network comprises multiple hidden layers employing a rectified linear unit (ReLU) activation function.

14. The system of claim 8, wherein the memory stores further instructions that, when executed by the one or more processors, cause the system to generate an optimized interconnect configuration based at least in part on the parameterized predictions, wherein generating the optimized interconnect configuration comprises adjusting at least one of trace width, dielectric properties, substrate thickness, or signal routing based at least in part on at least one of signal integrity requirements, impedance matching, or thermal constraints.

15. A non-transitory computer-readable medium storing instructions that, when executed by one or more processors, cause the one or more processors to:
define a set of interconnect models associated with interconnect structures in a semiconductor package, wherein each interconnect model encapsulates electrical characteristics of a corresponding interconnect structure;
cascade parameter data from each interconnect model of the set of interconnect models to generate a system-level interconnect simulation; and
encode the set of interconnect models into a predictive model that generates parameterized predictions based on interconnect design variations.

16. The non-transitory computer-readable medium of claim 15, wherein the set of interconnect models comprises at least one of a C4 bump model, a microstrip model, a stripline model, or a via model.

17. The non-transitory computer-readable medium of claim 15, further comprising instructions that, when executed by the one or more processors, cause the one or more processors to, prior to cascading the parameter data, validate the set of interconnect models against empirical measurement data by comparing at least one of s-parameter data, impedance characteristics, or loss parameters from the set of interconnect models against physical measurements obtained from fabricated test structures.

18. The non-transitory computer-readable medium of claim 15, wherein the predictive model comprises a feedforward neural network comprising multiple hidden layers employing a rectified linear unit (ReLU) activation function.

19. The non-transitory computer-readable medium of claim 15, further comprising instructions that, when executed by the one or more processors, cause the one or more processors to generate an optimized interconnect configuration based at least in part on the parameterized predictions, wherein generating the optimized interconnect configuration comprises adjusting at least one of trace width, dielectric properties, substrate thickness, or signal routing based at least in part on at least one of signal integrity requirements, impedance matching, or thermal constraints.

20. The non-transitory computer-readable medium of claim 19, further comprising instructions that, when executed by the one or more processors, cause the one or more processors to store the optimized interconnect configuration for reuse across multiple semiconductor packaging configurations.
